(19) United States
(12) Patent Application Publication
(10) Pub. No.: US 2011/0194742 A1
(43) Pub. Date: Aug. 11, 2011

(54) ONE-CLICK CORRECTION OF TUMOR SEGMENTATION RESULTS

(75) Inventors: Thomas Buelow, Grosshansdorf (DE); Rafael Wiemker, Kisdorf (DE)

(73) Assignee: KONINKLIJKE PHILIPS ELECTRONICS N.V., EINDHOVEN (NL)

(21) Appl. No.: 13/123,042

(22) PCT Filed: Oct. 6, 2009
(86) PCT No.: PCT/IB2009/054368

§ 371 Date: Apr. 7, 2011

Related U.S. Application Data
(60) Provisional application No. 61/105,215, filed on Oct. 14, 2008.

(51) Int. Cl. G06K 9/00

(52) U.S. Cl. 382/128

(57) ABSTRACT

When adjusting parameters of a segmentation protocol for segmenting a volume of interest in an anatomical image, a user selects a superparameter (50) that includes multiple internal parameters (52) for adjusting a raw segmentation of the volume interest. As a weight of the selected superparameter is adjusted, weights of the internal parameters associated with the superparameter are adjusted according to a superparameter segmentation adjustment algorithm (20). The volume of interest is iteratively re-segmented after each internal parameter adjustment, transparently to the user, until a predetermined amount of change has been effected in the volume of interest segmentation, at which time the re-segmented volume of interest is displayed to the user.

The present application finds particular utility in medical image volume segmentation. However, it will be appreciated that the described technique(s) may also find application in other types of imaging systems, image segmentation systems, and/or medical applications.

Segmentation of tumors is a central part in a multitude of clinical applications including tumor visualization, volumetry, input for a computer-assisted diagnosis (CADx) system, and therapy planning. Computer algorithms exist for the automatic or semi-automatic segmentation of tumors in images acquired from different scanner modalities such as computed tomography (CT), magnetic resonance (MR), positron emission tomography (PET), ultrasound, etc. The exact behavior of most of these algorithms can be tuned by a number of parameters. Independent of the performance of the segmentation algorithms, images often remain that cannot be automatically segmented satisfactorily in any case, due to ambiguous segmentation targets. For example, whether the foci of a multi-focal lesion should be segmented separately or the lesion should be segmented as a whole depends on the application and the user interest. The same holds for the width of a “safety margin” around the lesions that might be included in the segmented area.

The ambiguity in the desired segmentation results makes it necessary for the user to be able to correct the initial segmentation results presented by the computer. However, in many cases the parameters of an automatic segmentation algorithm are numerous and their meaning is not intuitive for the clinical user, resulting in the need to rerun the segmentation multiple times using different parameter settings until the desired result is obtained.

Segmentation algorithms are rather complex mathematical formulas, typically including six or more internal parameters such as thresholds, gradients, scalars, exponents limits, and the like. In the expert system that is primarily used at research sites, there is a screen page which enables the user to adjust each of the internal parameters. The mechanical formulas often include functions that interact with, and in some cases counteract, each other. Adjusting individual internal parameters requires an in-depth understanding of the equations and is typically not of interest to a diagnosing physician.

There is a need in the art for systems and methods that facilitate overcoming the deficiencies noted above by providing improved parameter adjustment mechanisms.

In accordance with one aspect, a medical image segmentation system includes a display on a user interface on which an initial segmented volume of interest is displayed to a user, a user input tool with which the user adjusts a weight of a superparameter of the segmented volume of interest, and a parameter adjuster that adjusts one or more internal parameters associated with the superparameter to effect a change in the segmented volume of interest. The system further includes a processor that iteratively re-segments the volume of interest after one or more internal parameter adjustments by the parameter adjuster and outputs the re-segmented volume to the display.

In accordance with another aspect, a method of adjusting a medical image segmentation includes displaying an initial segmentation of a volume of interest to a user, receiving information related to an adjustment of a weight of a selected superparameter, and identifying internal parameters included in the selected superparameter. The method further includes adjusting the identified internal parameters of the selected superparameter according to a parameter adjustment algorithm, re-segmenting the volume of interest after adjustment of one or more identified internal parameters, and displaying the re-segmented volume of interest.

In accordance with another aspect, an apparatus for concurrently adjusting a plurality of segmentation parameters for segmenting an anatomical image includes means for displaying an initial segmentation of a volume of interest to a user, means for receiving information related to an adjustment of a weight of a selected superparameter, and means for adjusting identified internal parameters of the selected superparameter. The apparatus further includes means for iteratively re-segmenting the volume of interest after adjustment of one or more identified internal parameters, means for calculating an amount of change effected in the volume of interest as a result of the adjustment to the one or more identified internal parameters, and means for outputting a final re-segmented volume of interest upon a determination that the calculated amount of change is greater than or equal to a predetermined threshold amount of change.

One advantage is that user adjustment of internal parameters is simplified.

Another advantage resides providing iterative segmentations of an image until a desired result is achieved by the user.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting.

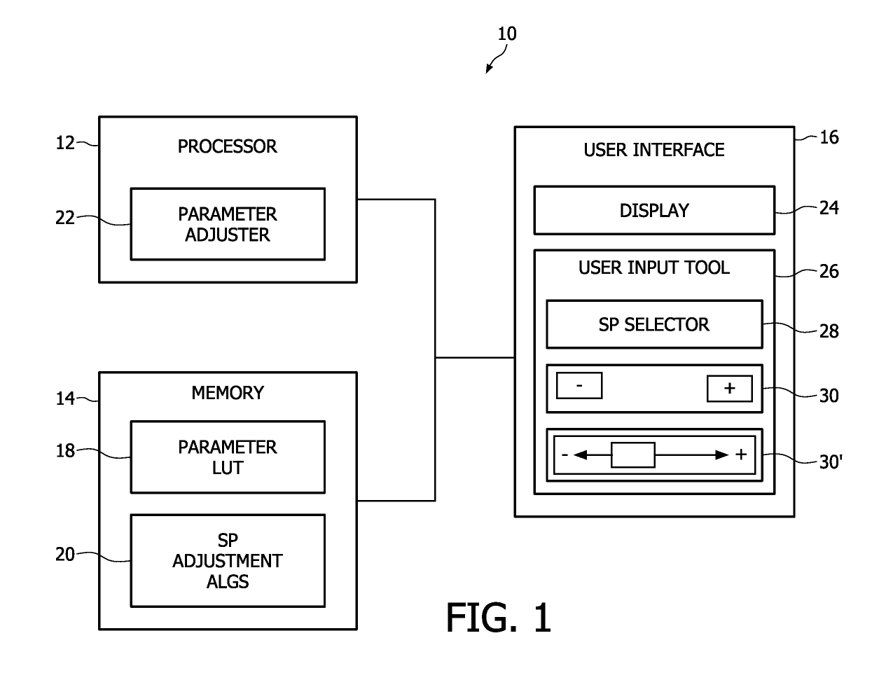

FIG. 1 illustrates a medical image segmentation system that combines individual segmentation parameters associated with a given segmentation feature into one or more “superparameters” that are adjustable by an operator (e.g., a physician, nurse, technician, etc.).

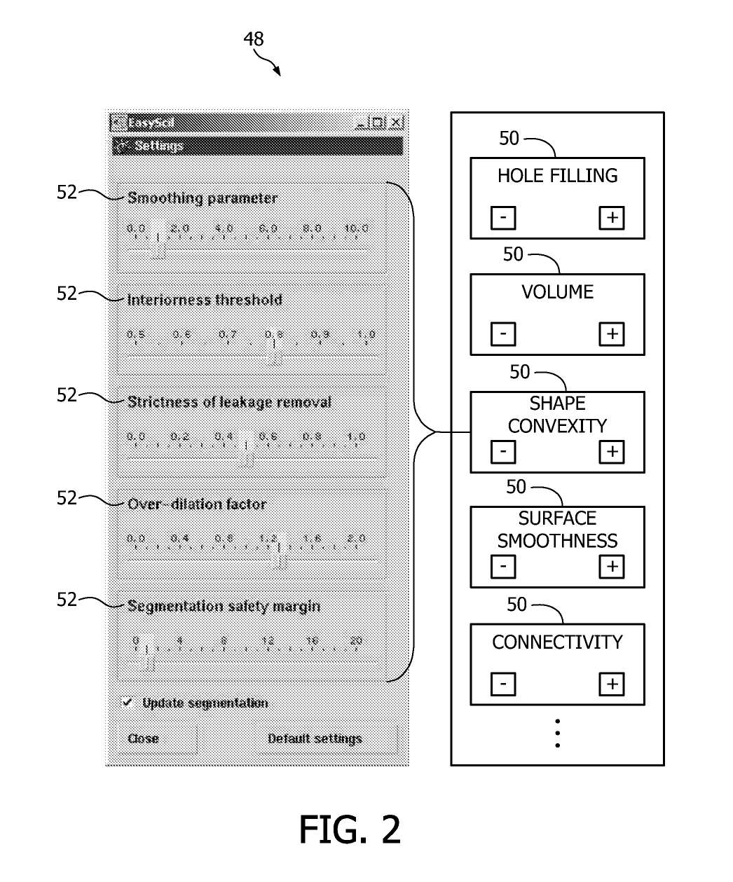

FIG. 2 illustrates an example of a superparameter, comprising a plurality of internal parameters that are automatically adjusted in response to user adjustment of the superparameter.

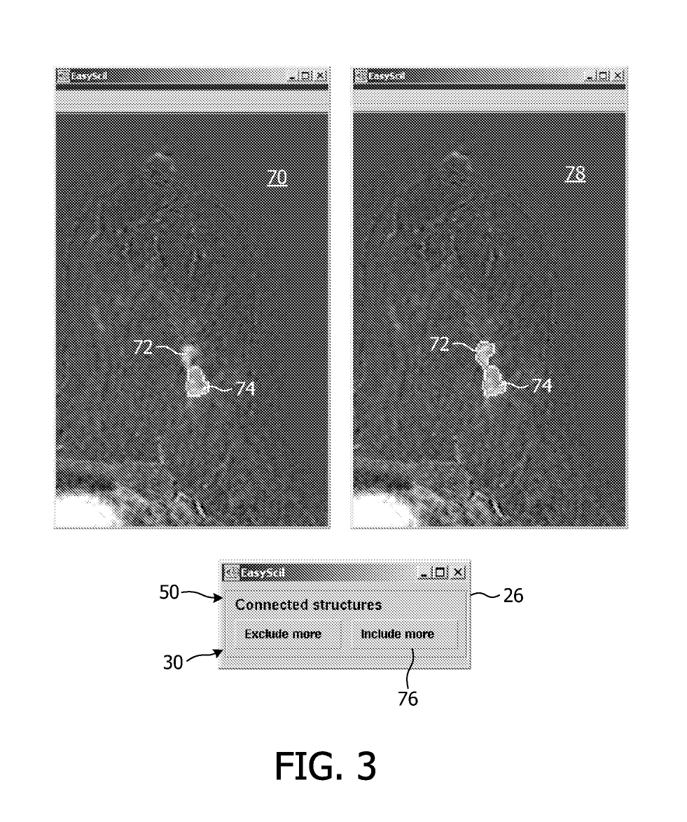

FIG. 3 illustrates images of a segmented mass lesion, before and after adjustment of a connected structures superparameter.

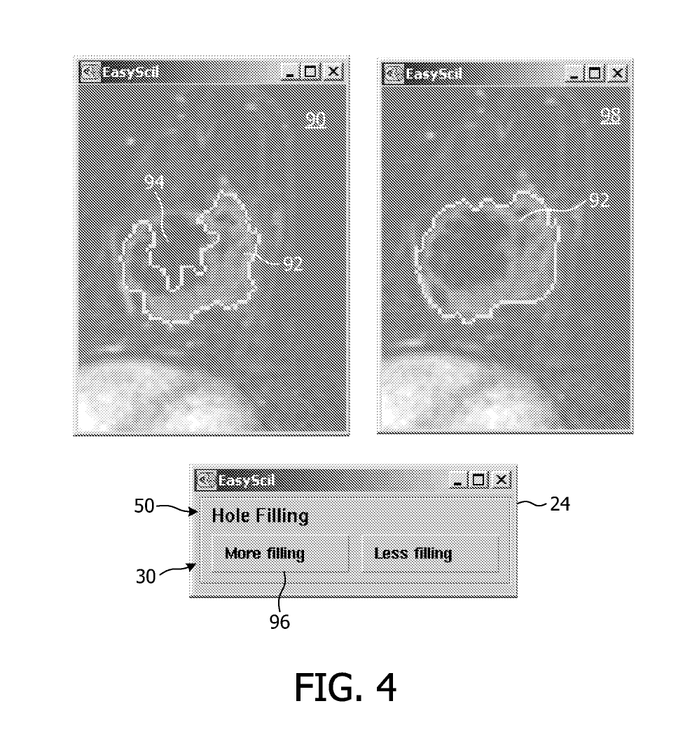

FIG. 4 shows images of a lesion before and after a hole-filling superparameter is adjusted.

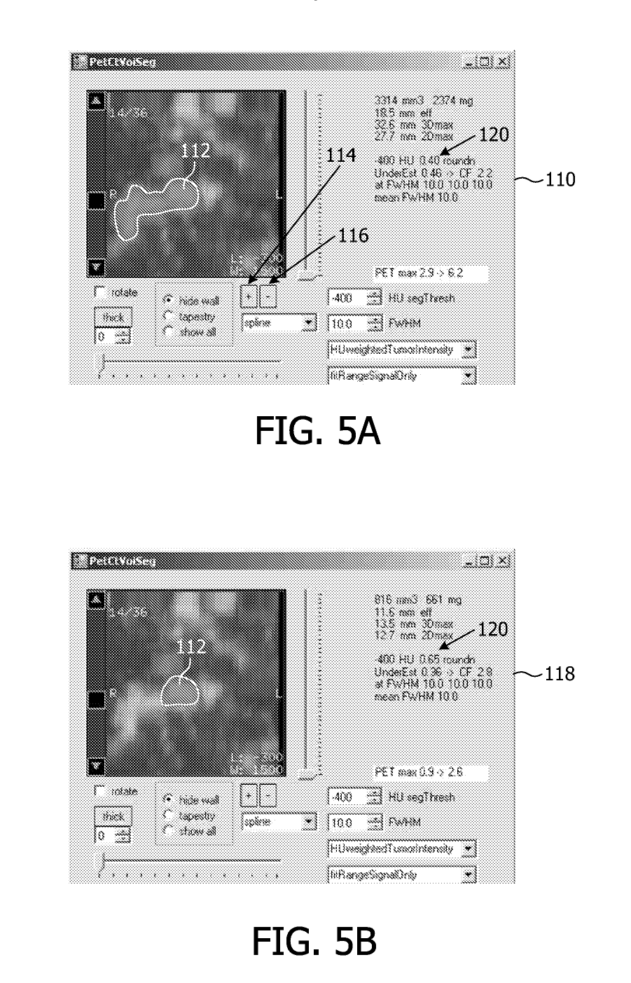

FIGS. 5A and 5B show screenshots of a segmented lung lesion including a pulmonary nodule, shown in a coronal maximum intensity projection. In a first screenshot, a lesion segmentation result is shown with “leakage” (FIG. 5A) and in FIG. 5B, the leakage superparameter has been reduced.

FIG. 1 illustrates a medical image segmentation system 10 for use in the computerized segmentation of an image volume through image segmentation algorithms that combine individual image segmentation parameters (e.g., thresholds, gradients, scalars, exponents, limits, etc.) that are adjusted to alter an image segmentation into one or more “superparameters” that are adjustable by an operator (e.g., a physician, nurse, technician, etc.) to alter or adjust an image segmentation feature (e.g., roundness, smoothness, volume, hole-filling, connectivity, etc.) associated with the superparameter. That is, adjustment of a superparameter triggers automatic adjustment of image segmentation parameters included in the superparameter (e.g., “internal” parameters) to effect a change in an image segmentation feature associated with the superparameter. For instance, image segmentation features include features of the imaged volume such as smoothness, roundness, volume, etc., and are governed by one or more parameters that may or may not be intuitively meaningful to a user. For example, an adjustment of a superparameter governing image segmentation roundness (e.g., shape convexity) triggers adjustment of one or more image segmentation parameter such as a smoothing parameter (e.g., a parameter internal to the roundness superparameter) that contributes to alteration of the roundness feature of the image segmentation for a volume of interest (e.g., a lesion or tumor, a soft tissue contour, etc.).

Superparameters of the system 10 therefore govern image segmentation features such as volume, surface smoothness, shape convexity (roundness), connectivity, hole-filling, and the like. To increase or decrease one of these superparameters by an incremental amount, a combination of the internal parameters (e.g., individual parameters included in the superparameter) need to be adjusted by differing incremental amounts. The relationship between the superparameters and the underlying internal parameters is linear in some situations and non-linear in others. The system 10 thus makes appropriate incremental adjustments to the internal parameters to make a small incremental adjustment in one of the superparameters, which typically is beyond the ability of the average diagnostician.

The system 10 is for example a part of a medical imaging workstation (e.g., a picture archiving and communication system (PACS) workstation or a CADx workstation, etc) or directly part of a scanner console, etc. The system 10 includes a processor 12 and memory 14, which are coupled to a user interface 16. The memory stores various computer-executable algorithms and/or information (e.g., image volume data, segmentation data, parameter information, superparameter information, etc.) related to performing the various functions described herein. For example, the memory includes a parameter lookup table 18 that stores internal parameter information and associated superparameters. For instance, a first internal subset of parameters is associated with a first superparameter, a second subset of parameters is associated with a second superparameter, and so on. Additionally, a given parameter may be associated with more than one superparameter. The memory further includes parameter adjustment algorithms 20, which are executed by a parameter adjuster 22 in the processor 12 to adjust parameters in a given superparameter in response to user adjustment of the superparameter via user interface 16.

The user interface 16 includes a display 24 on which image information is presented to a user, and a user input tool 26 by which the user adjusts the superparameter. For example, a user employs a superparameter selector 28 for selecting a superparameter related to a volume of interest or other image segmentation feature in an image on the display 24. For instance, a superparameter governing a buffer zone (e.g., 2 mm or the like) around a tumor or other anatomical structure can be adjusted (e.g., narrower or wider) depending on conditions associated with a given therapy plan (e.g., ablation, etc.), and the like.

The user adjusts the weight of the selected superparameter using a superparameter adjuster 30. As one illustrative example, the superparameter adjuster 30 includes buttons, such as (+) and (−) buttons that increase and decrease the weight of the parameter, respectively. The parameter adjuster 22 executes one or more of the parameter adjustment algorithms 20 to modify the weights of individual parameters in the selected superparameter in accordance with the adjustment to the weight of the superparameter.

The processor 12 re-segments the volume of interest according to the new weights of individual parameters as modified by the parameter adjuster 22, in a manner that is transparent to the user or alternatively in a manner that is visible to the user (e.g., in an expert or advanced mode). By repeatedly pressing a button on the superparameter adjuster 30, the diagnostician can step through a range of the superparameter weightings. In the background, the parameter adjuster executes a transform (which is one of the superparameter algorithms 20) that links the incremental steps of each button to corresponding incremental adjustments in the underlying internal parameters associated with the user-selected superparameter. It will be appreciated that the buttons on the superparameter adjuster 30, and/or the superparameter selector 28, may be physical buttons on a machine or device in which the system 10 is employed, or may be virtual buttons presented to the user on the display. Moreover, the superparameter adjuster is not limited to buttons comprising (+) and (−) indicators, but rather may include any suitable indicators to inform the user of the button functions (e.g., arrows, words such as “up” and “down,” “more” and “less,” etc.).

Additionally or alternatively, a superparameter adjuster 30′ is in the form of a slider bar (actual or virtual) that the user manipulates to increase or decrease the weight of a selected superparameter. One having ordinary skill in the art will understand that system 10 can also have any combination of mechanisms for a superparameter adjuster including a slider bar (actual or virtual), pressable or virtual buttons, etc.

By summarizing the possible parameter changes into groups that can be steered by modifying a single superparameter, which has an intuitive meaning to the clinical user, iterative segmentation of the volume of interest can be performed until the user is satisfied with the segmentation. In the background (e.g., transparently to the user), segmentation is rerun iteratively until a certain amount of change in the segmentation result has been reached. That is, the numerical segmentation parameters included in a selected superparameter are varied internally with repeated segmentations that are not shown to the user until a substantial change in, for instance, volume or compactness towards a desired direction has been achieved, and only the substantially changed segmentation result is presented to the user for re-evaluation. As one example, a substantial change is determined or measured as a function of a comparison to a predetermined threshold. The threshold may be set by the user or by the system, and is set to a desired percentage (e.g., 1%, 2%, 5%, 10%, 20%, etc.) of difference relative to a current segmentation image. The user can use the increment/decrement button(s) repeatedly until satisfied with the result, without concern for the actual numerical parameter values.

According to one example, the amount of change threshold for a volume of interest for which a volume superparameter is adjusted is set to 20%. The internal parameters are then adjusted according to a volume parameter adjustment algorithm until the volume has been decreased or increased by 20%.

The segmentation algorithms are capable of post-processing steps to include non-enhanced interior parts of a lesion or tumor, and to exclude enhanced tissue attached to but not part of the lesion (vessels, enhanced parenchyma, etc.). A hole-filling algorithm that “fills in” dark areas associated with necrotic tissue in a lesion in the image of the volume of interest includes interpolating voxel data from neighboring enhanced voxels in the image. That is, necrotic tumor tissue that does not absorb tracer and is thus not enhanced in the image appears as a dark area, while other tumor tissue that absorbs the tracer is enhanced. The hole-filling algorithm fills in the dark areas using voxel values from nearby enhanced areas of the tumor image to create a whole volume, which can be used for tumor volume calculations, surface identification, topography determinations, etc.

In one example of a use of system 10, an initial (e.g., raw) segmentation of a volume of interest is displayed to the user on the display 24, and the user selects and adjusts a superparameter via the user interface 16. Once the threshold amount of change has been met or exceeded, the processor 12 outputs a final segmentation of the volume of interest. The initial and final segmentations are displayed concurrently on the display 24 to permit user comparison. The user then accepts or rejects the final segmentation. If rejected, the final segmentation can be discarded or saved to memory 14, and the processor 12 retains the initial segmentation for another round of superparameter adjustment. If accepted, the final segmentation is stored to the memory 14 as a new “initial” segmentation for further superparameter adjustment as desired by the user. The original initial segmentation is also retained in the memory 14, or may be discarded.

FIG. 2 illustrates an exemplary display 48 of various superparameters 50, and a plurality of underlying internal parameters 52. For instance, the plurality of internal parameters 52 includes a smoothing parameter, an interiorness threshold parameter, a strictness of leakage removal parameter, an over-dilation factor parameter, a segmentation safety margin parameter, etc. Superparameters are based upon such features as volume, surface smoothness, shape convexity (roundness), connectivity, hole-filling, and the like. Upon a user incrementing or decrementing one (or more) of the superparameters 50, the corresponding internal parameters 52 are adjusted up or down in accordance with the adjustment algorithm 20 until a threshold level of change in the segmentation of the volume of interest is achieved.

FIG. 3 illustrates images of a segmented mass lesion. In the first image 70, two lobes 72, 74 of the lesion are shown, where the first lobe 72 has been identified as “leakage” and has been excluded from the segmentation result, while the second lobe 74 is included as lesion tissue. Leakage occurs when non-lesion tissue absorbs tracer material, and appears in an image of the lesion. For instance, since tumors induce blood vessels to grow toward them to supply nutrients, tracer or contrast agent sometimes “leaks” into such blood vessels, causing them to appear in an image of the tumor.

After a user has requested inclusion of more connected structures by a single mouse click of an “include more” button 76 on the superparameter adjuster 30 of the input tool 26, the first lobe 72 is included as part of the tumor (e.g., the first lobe is not identified as leakage, but rather as lesion tissue).

With regard to the inclusion of connected structures, the segmentation algorithms contain a post-processing step that rejects portions of the initial segmentation result on the basis of the width of the connection to the main part of the segmented lesions. For instance, a threshold on the maximum allowed degree of narrowing of a connection between, for instance, the first and second lobes 72, 74 of the lesion determines whether a connected portion is cut off (e.g., identified as leakage) or not. If the user requests more connected structures to be included in the segmented area, the allowed degree of narrowing is reduced in predefined steps. The post-processing step is repeated for each parameter setting, and the result is compared to the initial segmentation result. In this example, if the segmented area increases by a certain predefined amount (e.g., above the predefined threshold of change), the new result is presented to the user.

FIG. 4 shows images of a lesion before and after incrementing a hole-filling algorithm. A first image 90 shows a lesion 92 prior to the hole-filling algorithm, with a necrotic kernel 94 exhibiting poor tracer uptake, which appears as a dark area in the first image. Many tumors contain such necrotic areas, which do not take up contrast agent and thus do not show enhancement of the image intensity. A user can select a hole-filling superparameter 50 to adjust the amount of dark area that is included in the segmentation. For instance, the user can click on or otherwise select a “more filling” button on the superparameter adjuster 30 of the user input tool 26 to include more or all of the dark areas in the lesion volume. The segmenting algorithm can increase or otherwise adjust an “interiorness threshold” parameter to fill in the dark areas, until the lesion 92 is sufficiently filled in to permit a determination of lesion volume, surface characteristics, etc., as shown in the second image 98.

FIGS. 5A and 5B show screenshots of a segmented lung lesion including a pulmonary nodule, shown in a coronal maximum intensity projection. In a first screenshot 110, a lesion 112 segmentation result is shown with “leakage.” A graphical user interface (GUI) has a “plus” button 114 and a “minus” button 116 to request more or less volume or compactness. A second screenshot 118 of FIG. 5B shows the lesion 112 after the user has requested reduced volume by using the minus button 116, and the leakage has disappeared. To achieve this, the segmentation algorithm has varied a “roundness” superparameter 120 in several steps and has run repeated segmentations until the volume was reduced by a predetermined amount (e.g., 20%, etc.) with respect to the segmentation shown to the user.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A medical image segmentation system (10), including:
a display (24) on a user interface (16) on which an initial segmented volume of interest is displayed to a user;
user input tool (26) with which the user adjusts a weight of a superparameter (50) of the segmented volume of interest;
a parameter adjuster (22) that adjusts one or more internal parameters (52) associated with the superparameter to effect a change in the segmented volume of interest; and
a processor (12) that iteratively re-segments the volume of interest after one or more internal parameter adjustments by the parameter adjuster (22) and outputs the re-segmented volume to the display.

2. The system according to claim 1, wherein the user interface (16) further includes a superparameter selector (28) that a user employs to select a superparameter (50) for adjustment.

3. The system according to claim 2, wherein the user interface (16) further includes a superparameter adjuster (30) that a user employs to adjust the weight of a selected superparameter.

4. The system according to claim 3, wherein the superparameter adjuster (30) includes at least one of:
a first button for increasing the weight of the selected superparameter, and a second button for decreasing the weight of the selected superparameter, as the selected superparameter is applied in a segmentation algorithm executed on the volume of interest; or
a slider bar (30′) that user manipulates to adjust the weight of a selected superparameter.

5. The system according to claim 1, wherein the superparameter (50) is one or more of a volume superparameter, surface smoothness superparameter, roundness superparameter, connectivity superparameter, or hole-filling superparameter.

6. The system according to claim 1, wherein the internal parameters (52) include one or more of a smoothing parameter, an interiorness threshold parameter, a strictness of leakage removal parameter, an over-dilation factor parameter, a segmentation safety margin parameter.

7. The system according to claim 1, further including a memory (14) that stores:
a parameter lookup table (18) that identifies one or more internal parameters associated with each of a plurality of superparameters; and
one or more parameter adjustment algorithms (20), which, when executed by the processor (12), cause the parameter adjuster to adjust internal parameters until the predetermined threshold amount of change has been met or exceeded.

8. The system according to claim 1, wherein the processor compares each re-segmented volume of interest to the initial segmented volume of interest to determine an amount of change caused by each internal parameter adjustment, and outputs a final re-segmented volume of interest upon a determination that a predetermined threshold amount of change has been met or exceeded by the one or more internal parameter adjustments.

9. The system according to claim 1, wherein the processor (12) executes machine-executable instructions stored in the memory (14) for segmenting the volume of interest, including instructions for:
generating the initial segmentation of the volume of interest;
receiving information related to an adjustment of the selected superparameter (50);
identifying internal parameters (52) included in the selected superparameter (50);
adjusting the identified internal parameters (52) according to a parameter adjustment algorithm (20);
re-segmenting the volume of interest after adjustment of one or more identified internal parameters (52);
calculating an amount of change effected in the volume of interest as a result of the adjustment to the one or more identified internal parameters (52); and
outputting a final re-segmented volume of interest upon a determination that the calculated amount of change is greater than or equal to a predetermined threshold amount of change.

10. A method of adjusting a volume of interest segmentation using the system according to claim 1, including:
generating the initial segmentation of the volume of interest;
receiving information related to an adjustment of the selected superparameter (50);
identifying internal parameters (52) included in the selected superparameter (50);
adjusting the identified internal parameters (52) according to a parameter adjustment algorithm (20);
re-segmenting the volume of interest after adjustment of one or more identified internal parameters (52); and
displaying the re-segmented volume of interest.

11. The method according to claim 10, further including:
calculating an amount of change effected in the volume of interest as a result of the adjustment to the one or more identified internal parameters (52); and
outputting a final re-segmented volume of interest upon a determination that the calculated amount of change is greater than or equal to a predetermined threshold amount of change.

12. A method of adjusting a medical image segmentation, including:
displaying an initial segmentation of a volume of interest to a user;
receiving information related to an adjustment of a weight of a selected superparameter (50);
identifying internal parameters (52) included in the selected superparameter (50);
adjusting the identified internal parameters (52) of the selected superparameter (50) according to a parameter adjustment algorithm (20);
re-segmenting the volume of interest after adjustment of one or more identified internal parameters (52); and
displaying the re-segmented volume of interest.

13. The method according to claim 12, wherein the superparameter (50) is at least one of a volume superparameter, surface smoothness superparameter, roundness superparameter, connectivity superparameter, or hole-filling superparameter.

14. The method according to claim 13, wherein the internal parameters include one or more of a smoothing parameter, an interiorness threshold parameter, a strictness of leakage removal parameter, an over-dilation factor parameter, a segmentation safety margin parameter.

15. The method according to claim 12, further including:
iteratively re-segmenting the volume of interest after adjustment of one or more identified internal parameters (52);
calculating an amount of change effected in the volume of interest as a result of the adjustment to the one or more identified internal parameters (52); and
outputting a final re-segmented volume of interest upon a determination that the calculated amount of change is greater than or equal to a predetermined threshold amount of change.

16. The method according to claim 15, further including displaying the initial segmentation of the volume of interest and the final segmentation of the volume of interest concurrently to the user.

17. The method according to claim 16, further including:
storing the final segmentation of the volume of interest for further superparameter adjustment upon acceptance of the final segmentation by the user; or
reverting to the initial segmentation of the volume of interest for further superparameter adjustment upon rejection of the final segmentation by the user.

18. A processor (12) or computer-readable medium (14) configured to execute the method of claim 12.

19. An apparatus for concurrently adjusting a plurality of segmentation parameters (52) for segmenting an anatomical image, including:
means (24) for displaying an initial segmentation of a volume of interest to a user;
means (12, 30, 30′) for receiving information related to an adjustment of a weight of a selected superparameter (50);
means (12, 18, 20, 22) for adjusting identified internal parameters (52) of the selected superparameter (50);
means (12) for iteratively re-segmenting the volume of interest after adjustment of one or more identified internal parameters (52);
means (12) for calculating an amount of change effected in the volume of interest as a result of the adjustment to the one or more identified internal parameters (52); and
means (12, 24) for outputting a final re-segmented volume of interest upon a determination that the calculated amount of change is greater than or equal to a predetermined threshold amount of change.
